(19) United States
(12) Patent Application Publication
(10) Pub. No.: US 2026/0350287 A1
(43) Pub. Date: Nov. 5, 2026

(54) VOLTAGE CONVERSION METHOD AND APPARATUS IN SIMULATION CIRCUIT, ELECTRONIC DEVICE AND NON-TRANSITORY COMPUTER-READABLE STORAGE MEDIUM

(71) Applicant: PRIMARIUS TEHCNOLOGIES CO., LTD., Shanghai (CN)

(72) Inventors: Xiangkai WANG, Shanghai (CN); Yihui LI, Shanghai (CN); Jun FANG, Shanghai (CN)

(73) Assignee: PRIMARIUS TEHCNOLOGIES CO., LTD., Shanghai (CN)

(21) Appl. No.: 19/721,026

(22) Filed: Jun. 26, 2026

Related U.S. Application Data
(63) Continuation of application No. PCT/CN2024/138096, filed on Dec. 10, 2024.

(30) Foreign Application Priority Data
Dec. 28, 2023 (CN) 2023118459694

(51) Int. Cl. G06F 30/38; G06F 115/08

(52) U.S. Cl. CPC G06F 30/38; G06F 2115/08

(57) ABSTRACT

The present application provides a voltage conversion method in a simulation circuit. The method can obtain time points at which a voltage source reaches a low threshold voltage and a high threshold voltage; insert calculation breakpoints at the respective time points; and calculate a first voltage value, a second voltage value and a third voltage value according to the calculation breakpoints during simulation of the voltage source, and convert the voltage values into digital signals. According to the present application, variations of the voltage source are solved based on the calculation breakpoints, and invalid calculations are avoided, thereby improving the simulation speed and efficiency.

### CROSS-REFERENCE TO RELATED APPLICATIONS

The present application is a Continuation of PCT Patent Application No. PCT/CN 2024/138096 filed on Dec. 10 2024, which claims priority to Chinese Patent Application No. 2023118459694 filed on Dec. 28, 2023. The contents of the above-identified applications are incorporated herein by reference.

### TECHNICAL FIELD

The present application relates to the technical field of integrated circuit design, and in particular to a voltage conversion method and apparatus in a simulation circuit, an electronic device, and a non-transitory computer-readable storage medium.

### BACKGROUND

With the continuous development of electronic circuit technology, integrated circuits have been widely used. As industrial production demands increasingly higher performance from electronic circuits, the scale of integrated circuits continues to increase, and their integration density has also become higher. Meanwhile, in the field of electronic devices, the proportion of mixed-signal integrated products is increasing year by year, and the variety of such products is continuously increasing, accompanied by rising demand. The development of the mixed-signal integrated products has made mixed-signal circuit simulation a very active and popular subject in the current Electronic Design Automation (EDA) field.

Currently, in mixed-signal circuit simulation, an analog portion may include a high-frequency piecewise linear (PWL) voltage source, which is connected to a digital portion. In such a case, a simulator converts a voltage value (a real number) of the voltage source into a digital signal. However, in the solving process of the simulator, since a digital change will be triggered when the voltage of the voltage source rises to a low threshold voltage and a high threshold voltage, the simulator may discard the calculation results and perform the solving again. For a high-frequency varying voltage source, this can significantly reduce the simulation speed.

### SUMMARY

The present application provides a voltage conversion method and apparatus in a simulation circuit, an electronic device, and a non-transitory computer-readable storage medium. Calculation breakpoints can be inserted when a voltage source reaches a low threshold voltage and a high threshold voltage, so that variations of the voltage source are solved based on the calculation breakpoints, and invalid calculations are avoided, thereby improving the overall simulation speed and efficiency.

The present application provides a voltage conversion method in a simulation circuit, including:
during simulation of a mixed-signal circuit, obtaining a first time point at which a voltage source reaches a low threshold voltage and a second time point at which the voltage source reaches a high threshold voltage;
inserting calculation breakpoints at the first time point and the second time point, respectively;
during simulation of the voltage source, calculating a first voltage value, a second voltage value and a third voltage value according to the calculation breakpoints; and
converting the first voltage value, the second voltage value and the third voltage value into digital signals, respectively.

Optionally, the step of calculating the first voltage value, the second voltage value and the third voltage value according to the calculation breakpoints includes:
calculating the first voltage value of the voltage source from 0 to the low threshold voltage according to a first calculation breakpoint;
calculating the second voltage value of the voltage source from the low threshold voltage to the high threshold voltage according to the first calculation breakpoint and a second calculation breakpoint; and
calculating the third voltage value of the voltage source from the high threshold voltage to a maximum value according to the second calculation breakpoint.

Optionally, before the step of obtaining the first time point and the second time point, the method further includes:
determining whether the voltage source is a high-frequency linear voltage source; and
if the voltage source is the high-frequency linear voltage source, proceeding to perform the step of obtaining the first time point and the second time point.

Optionally, the step of obtaining the first time point at which the voltage source reaches the low threshold voltage and the second time point at which the voltage source reaches the high threshold voltage includes:
obtaining a rate of change of the high-frequency linear voltage source; and
calculating the first time point according to the rate of change and the low threshold voltage, and calculating the second time point according to the rate of change and the high threshold voltage.

Optionally, the step of converting the first voltage value, the second voltage value and the third voltage value into the digital signals, respectively includes:
when the first voltage value, the second voltage value or the third voltage value is less than or equal to the low threshold voltage, setting a digital signal value correspondingly connected to the voltage source to 0;
when the first voltage value, the second voltage value or the third voltage value is greater than or equal to the high threshold voltage, setting a digital signal value correspondingly connected to the voltage source to 1; and
when the first voltage value, the second voltage value or the third voltage value is greater than the low threshold voltage and less than the high threshold voltage, setting a digital signal value correspondingly connected to the voltage source to x, where x is a logic value of an intermediate state.

The present application further provides a voltage conversion apparatus in a simulation circuit, including:
an obtaining module, configured to, during simulation of a mixed-signal circuit, obtain a first time point at which a voltage source reaches a low threshold voltage and a second time point at which the voltage source reaches a high threshold voltage;
an insertion module, configured to insert calculation breakpoints at the first time point and the second time point, respectively;
a calculation module, configured to, during simulation of the voltage source, calculate a first voltage value, a second voltage value and a third voltage value according to the calculation breakpoints; and
a conversion module, configured to convert the first voltage value, the second voltage value and the third voltage value into digital signals, respectively.

Optionally, the obtaining module includes:
an obtaining submodule, configured to obtain a rate of change of a high-frequency linear voltage source; and
a first calculation submodule, configured to calculate the first time point according to the rate of change and the low threshold voltage, and calculate the second time point according to the rate of change and the high threshold voltage.

Optionally, the calculation module includes:
a second calculation submodule, configured to calculate the first voltage value of the voltage source from 0 to the low threshold voltage according to a first calculation breakpoint;
a third calculation submodule, configured to calculate the second voltage value of the voltage source from the low threshold voltage to the high threshold voltage according to the first calculation breakpoint and a second calculation breakpoint; and
a fourth calculation submodule, configured to calculate the third voltage value of the voltage source from the high threshold voltage to a maximum value according to the second calculation breakpoint.

The present application further provides an electronic device, including: a memory and a processor, where the memory stores a computer program, and the processor performs the steps of any voltage conversion method in the simulation circuit provided by the present application by invoking the computer program.

The present application further provides a non-transitory computer-readable storage medium that stores a computer program, and the computer program is executed by a processor to perform the steps of any voltage conversion method in the simulation circuit provided by the present application.

According to the voltage conversion method in the simulation circuit provided by the present application, during simulation of the mixed-signal circuit, the first time point at which the voltage source reaches the low threshold voltage and the second time point at which the voltage source reaches the high threshold voltage can be obtained; the calculation breakpoints are inserted at the first time point and the second time point, respectively; and when the voltage source is simulated, the first voltage value, the second voltage value and the third voltage value are calculated according to the calculation breakpoints, and the first voltage value, the second voltage value and the third voltage value are converted into the digital signals, respectively. According to the present application, the calculation breakpoints are inserted when the voltage source reaches the low threshold voltage and the high threshold voltage, so that variations of the voltage source are solved based on the calculation breakpoints, and invalid calculations are avoided, thereby improving the overall simulation speed and efficiency.

### BRIEF DESCRIPTION OF DRAWINGS

To describe the technical solutions of the present application more clearly, the accompanying drawings required for describing the embodiments will be briefly introduced below. Apparently, the accompanying drawings described hereinafter only cover some embodiments of the present application, and those skilled in the art can derive other drawings from these drawings without creative efforts.

FIG. 1 is a first schematic flowchart of a voltage conversion method in a simulation circuit according to an embodiment of the present application;

FIG. 2 is a second schematic flowchart of a voltage conversion method in a simulation circuit according to an embodiment of the present application;

FIG. 3 is a first schematic structural diagram of a voltage conversion apparatus in a simulation circuit according to an embodiment of the present application;

FIG. 4 is a second schematic structural diagram of a voltage conversion apparatus in a simulation circuit according to an embodiment of the present application; and

FIG. 5 is a schematic structural diagram of an electronic device according to an embodiment of the present application.

### DETAILED DESCRIPTION OF THE EMBODIMENTS

Exemplary embodiments will be described in detail here, and examples thereof are shown in the accompanying drawings. When the following description refers to the accompanying drawings, the same reference numerals in different drawings represent the same or similar elements, unless otherwise specified. The implementation manners described in the following exemplary embodiments do not cover all implementation methods consistent with the present application. Instead, they are merely examples of apparatuses and methods consistent with some aspects of the present application as detailed in the appended claims.

It should be noted that, in this specification, the terms “comprise”, “include” or any other variants thereof are intended to cover non-exclusive inclusions. Specifically, a process, method, article, or apparatus that includes a series of elements shall include not only those elements but also other elements that are not explicitly listed or inherently associated with such a process, method, article, or apparatus. Without additional limitations, an element defined by the phrase “including one . . . ” does not exclude the presence of additional identical elements in the process, method, article, or apparatus that includes the element. Furthermore, components, features, or elements with the same names in different embodiments of the present application may have the same or different connotations, and their specific meanings shall be determined based on their interpretation in the specific embodiment or further in conjunction with the context of that embodiment.

It should be understood that although the steps in the flowcharts of the embodiments of the present application are shown sequentially by arrows, these steps are not necessarily executed in the sequence indicated by the arrows. Unless explicitly stated otherwise in this specification, there is no strict sequential restriction on the execution of these steps, and they may be executed in other sequences. Moreover, at least some of the steps in the drawings may include a plurality of sub-steps or stages, which are not necessarily completed simultaneously but may be executed at different times. The order of execution is not necessarily sequential; instead, it may be executed alternately or in rotation with at least a part of other steps and their sub-steps or stages.

It should be noted that in this application, step codes such as 101 and 102 are used to express the corresponding content more clearly and concisely, without imposing substantial limitations on the order of the steps. Those skilled in the art may perform step 102 prior to step 101 in practical implementation, and all such variations shall fall within the protection scope of the present application.

“Embodiment” mentioned herein means that the specific features, structures or characteristics described with reference to the embodiments may be included in at least one embodiment of the present application. The appearances of this phrase at various positions in the specification do not necessarily indicate the same embodiment, nor independent or alternative embodiments that are mutually exclusive of other embodiments. It is understood explicitly and implicitly by those skilled in the art that the embodiments described herein can be combined with other embodiments.

Embodiments of the present application provide a voltage conversion method in a simulation circuit. The method may be performed by a voltage conversion apparatus in the simulation circuit provided in the embodiments herein, or by a server integrated with such an apparatus. The voltage conversion apparatus in the simulation circuit may be implemented in hardware or software.

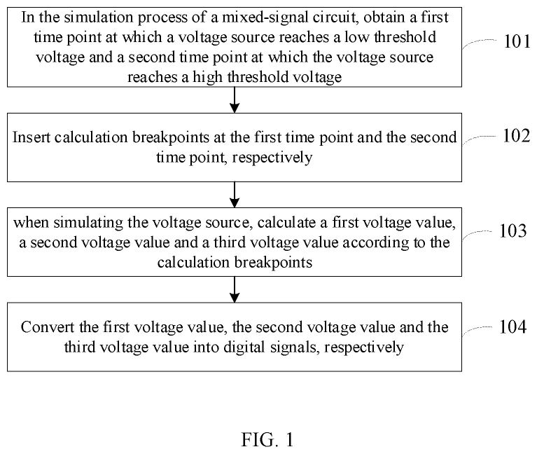

As shown in FIG. 1, FIG. 1 is a first schematic flowchart of a voltage conversion method in a simulation circuit according to an embodiment of the present application. The specific flow of the voltage conversion method in the simulation circuit may be as follows:
101. in the simulation process of a mixed-signal circuit, a first time point at which a voltage source reaches a low threshold voltage and a second time point at which the voltage source reaches a high threshold voltage are obtained.

Specifically, the mixed-signal simulation is a method that combines analog and digital simulation for system-level and circuit-level verification of an entire electronic system. The mixed-signal simulation can simulate the interaction between digital signals and analog signals, including factors such as clocks, data transmission, power supplies, and noise. The basic flow thereof includes: the system specifications and requirements are determined first, then a system simulation model is designed, a digital circuit design is implemented and verified, an analog circuit design is implemented and verified, then system-level simulation is performed, and optimization and iterative design are performed.

During simulation of the mixed-signal circuit, a simulator needs to solve for variations of the voltage source in an analog portion and then convert them into digital signals. However, for a piecewise linear voltage source, when rising from 0 to vdd (a maximum value), the voltage of the voltage source will sequentially pass through two threshold points: vl (the low threshold voltage) and vh (the high threshold voltage). At this time, the simulator first performs a solving from 0 to vdd. However, since a digital transition is required to be triggered when the voltage rises to vl, this result is discarded, and a solving from 0 to vl is performed again. Then, another solving from vl to vdd is performed. Since a digital transition is required to be triggered when the voltage rises to vh, this result is discarded, and a solving from vl to vh is performed again. Finally, another solving from vh to vdd is performed. The above steps require the simulator to solve five times, and two of the solving results are discarded, resulting in a certain amount of wasted computational resources and low efficiency. Therefore, in the embodiments of the present application, it is necessary to pre-find the first time point at which the voltage source reaches the low threshold voltage and the second time point at which the voltage source reaches the high threshold voltage, so that the simulator can be directly controlled to perform the solving from 0 to vl, from vl to vh, and finally from vh to vdd, thereby skipping the solving processes that would trigger the digital transitions.

It should be noted that, in the embodiments of the present application, two conditions are required to be satisfied: first, the voltage source is a high-frequency PWL voltage source; and second, the voltage source is required to be directly connected to a digital module. That is, before the step of obtaining the first time point and the second time point, the method further includes: determining whether the voltage source is a high-frequency linear voltage source and is directly connected to a digital module; and if the voltage source is the high-frequency linear voltage source and is directly connected to the digital module, the step of obtaining the first time point and the second time point is subsequently performed. Herein, PWL is an abbreviation for piecewise linear, that is, the PWL voltage source is a piecewise linear voltage source, which is a voltage source that generates a waveform by plotting points.
102. calculation breakpoints are inserted at the first time point and the second time point, respectively.

In the embodiments of the present application, after the first time point at which the voltage source reaches the low threshold voltage and the second time point at which the voltage source reaches the high threshold voltage are obtained, the calculation breakpoints can be directly inserted at the first time point and the second time point, respectively, thereby skipping the solving process that will trigger a digital transition.
103. when the voltage source is simulated, a first voltage value, a second voltage value and a third voltage value are calculated according to the calculation breakpoints.

In one embodiment, since the calculation breakpoints are inserted at the first time point and the second time point, respectively, when the simulator simulates the variation of the voltage source from 0 to vdd, the change from 0 to vl will be solved first, then the change from vl to vh will be solved, and finally, the change from vh to vdd will be solved, thereby sequentially obtaining the first voltage value, the second voltage value and the third voltage value. The above steps require only three solving operations by the simulator, and there is no operation of discarding the solving results. Compared with the case where no calculation breakpoints are inserted, the simulator skips two solving processes, so that the simulation efficiency is greatly accelerated, and the simulation performance can be improved by about 40%.
104. the first voltage value, the second voltage value and the third voltage value are converted into digital signals, respectively.

After the corresponding voltages (i.e., the first voltage value, the second voltage value and the third voltage value) are obtained through the three solving processes described above, the voltages can be converted into corresponding digital signals. Specifically, the digital signals may include a plurality of logic values, namely 0, 1, x and z, where x represents a logic value of an intermediate state and z represents a logic value of a high-impedance state. After conversion into the digital signal values, the analog states are effectively converted into digital states and transmitted to the digital simulation portion, which then performs further simulation according to changes of the received digital signal values.

As described above, in the voltage conversion method in the simulation circuit according to the embodiments of the present application, during simulation of the mixed-signal circuit, the first time point at which the voltage source reaches the low threshold voltage and the second time point at which the voltage source reaches the high threshold voltage can be obtained; the calculation breakpoints are inserted at the first time point and the second time point, respectively; and when the voltage source is simulated, the first voltage value, the second voltage value and the third voltage value are calculated according to the calculation breakpoints, and the first voltage value, the second voltage value and the third voltage value are converted into the digital signals, respectively. According to the present application, the calculation breakpoints are inserted when the voltage source reaches the low threshold voltage and the high threshold voltage, so that variations of the voltage source are solved based on the calculation breakpoints, and invalid calculations are avoided, thereby improving the overall simulation speed and efficiency.

According to the methods described in the foregoing embodiments, further detailed descriptions will be provided below.

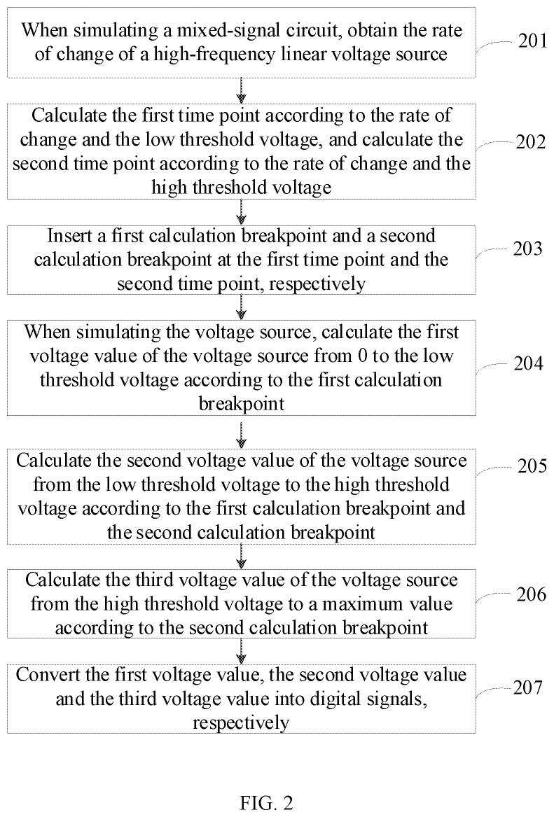

Referring to FIG. 2, FIG. 2 is a second schematic flowchart of a voltage conversion method in a simulation circuit according to an embodiment of the present application. The method includes:
201. when a mixed-signal circuit is simulated, the rate of change of a high-frequency linear voltage source is obtained.
202. the first time point is calculated according to the rate of change and the low threshold voltage, and the second time point is calculated according to the rate of change and a high threshold voltage.

In one embodiment, two conditions need to be satisfied in the embodiments of the present application: first, the voltage source is a high-frequency PWL voltage source; and second, the voltage source needs to be directly connected to a digital module.

During simulation of the mixed-signal circuit, it is necessary to pre-find the first time point at which the voltage source reaches the low threshold voltage vl and the second time point at which the voltage source reaches the high threshold voltage vh. Since the voltage source is a linear voltage source, its rate of change can be obtained, thereby pre-calculating the time points at which the voltage reaches vl and vh.
203. a first calculation breakpoint and a second calculation breakpoint are inserted at the first time point and the second time point, respectively.

In the embodiments of the present application, after the first time point at which the voltage source reaches the low threshold voltage and the second time point at which the voltage source reaches the high threshold voltage are obtained, the calculation breakpoints can be directly inserted at the first time point and the second time point.
204. when the voltage source is simulated, the first voltage value of the voltage source from 0 o the low threshold voltage is calculated according to the first calculation breakpoint.
205. the second voltage value of the voltage source from the low threshold voltage to the high threshold voltage is calculated according to the first calculation breakpoint and the second calculation breakpoint.
206. the third voltage value of the voltage source from the high threshold voltage to a maximum value is calculated according to the second calculation breakpoint.

When rising from 0 to vdd, the voltage of the voltage source sequentially passes through the two points vl and vh. Due to the presence of the two calculation breakpoints, the simulator first performs a solving from 0 to vl, then performs another solving from vl to vh, and finally performs a solving from vh to vdd. The above steps require only three solving operations by the simulator, and there are no operations of discarding the solving results.
207. the first voltage value, the second voltage value and the third voltage value are converted into digital signals, respectively.

In one embodiment, after the corresponding voltages are obtained through the three solving processes described above, the voltages can be converted into corresponding digital signals. Specifically, the digital signals may include a plurality of logic values, namely 0, 1, x and z, where x represents a logic value of an intermediate state and z represents a logic value of a high-impedance state. Specifically, assuming that the voltage value of the voltage source is v, the maximum value is vdd, the high threshold voltage is vh, and the low threshold voltage is vl, then when v<=vl, the digital signal value connected to the voltage source becomes 0; when v>=vh, the digital signal value connected to the voltage source becomes 1; and when vl<v<vh, the digital signal value connected to the voltage source becomes x. That is, the step of converting the first voltage value, the second voltage value and the third voltage value into the digital signals, respectively may include: when the first voltage value, the second voltage value, or the third voltage value is less than or equal to the low threshold voltage, a digital signal value correspondingly connected to the voltage source is set to 0; when the first voltage value, the second voltage value or the third voltage value is greater than or equal to the high threshold voltage, a digital signal value correspondingly connected to the voltage source is set to 1; and when the first voltage value, the second voltage value or the third voltage value is greater than the low threshold voltage and less than the high threshold voltage, a digital signal value correspondingly connected to the voltage source is set to x, where x is a logic value of an intermediate state.

As described above, according to the voltage conversion method in the simulation circuit provided by the embodiments of the present application, during simulation of the mixed-signal circuit, a rate of change of the high-frequency linear voltage source can be obtained; the first time point is calculated according to the rate of change and the low threshold voltage; the second time point is calculated according to rate of change and the high threshold voltage; the first calculation breakpoint and the second calculation breakpoint are inserted at the first time point and the second time point, respectively; during simulation of the voltage source, the first voltage value of the voltage source from 0 to the low threshold voltage is calculated according to the first calculation breakpoint; the second voltage value of the voltage source from the low threshold voltage to the high threshold voltage is calculated according to the first calculation breakpoint and the second calculation breakpoint; the third voltage value of the voltage source from the high threshold voltage to the maximum value is calculated according to the second calculation breakpoint; and the first voltage value, the second voltage value, and the third voltage value are converted into the digital signals, respectively. According to the present application, the calculation breakpoints are inserted when the voltage source reaches the low threshold voltage and the high threshold voltage, so that variations of the voltage source are solved based on the calculation breakpoints, and invalid calculations are avoided, thereby improving the overall simulation speed and efficiency.

To implement the above method, an embodiment of the present application further provides a voltage conversion apparatus in a simulation circuit. The voltage conversion apparatus in the simulation circuit may be specifically integrated into a terminal device such as a mobile phone, a tablet computer, or the like.

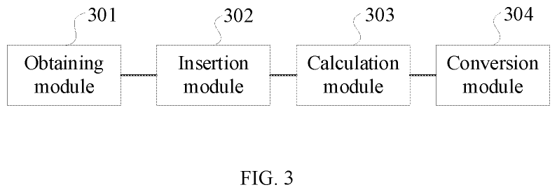

For example, as shown in FIG. 3, FIG. 3 is a first schematic structural diagram of a voltage conversion apparatus in a simulation circuit according to an embodiment of the present application. The voltage conversion apparatus in the simulation circuit may include:
an obtaining module 301, configured to, during simulation of a mixed-signal circuit, obtain a first time point at which a voltage source reaches a low threshold voltage and a second time point at which the voltage source reaches a high threshold voltage;
an insertion module 302, configured to insert calculation breakpoints at the first time point and the second time point, respectively;
a calculation module 303, configured to, during simulation of the voltage source, calculate a first voltage value, a second voltage value and a third voltage value according to the calculation breakpoints; and
a conversion module 304, configured to convert the first voltage value, the second voltage value, and the third voltage value into digital signals, respectively.

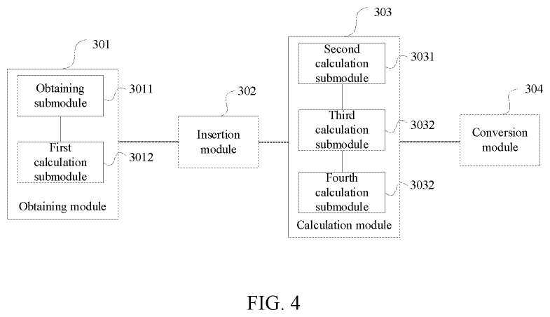

In one embodiment, referring to FIG. 4, the obtaining module 301 may specifically include:
an obtaining submodule 3011, configured to obtain a rate of change of a high-frequency linear voltage source; and
a first calculation submodule 3012, configured to calculate the first time point according to the rate of change and the low threshold voltage, and calculate the second time point according to the rate of change and the high threshold voltage.

In one embodiment, the calculation module 303 may specifically include:
a second calculation submodule 3031, configured to calculate the first voltage value of the voltage source from 0 to the low threshold voltage according to a first calculation breakpoint;
a third calculation submodule 3032, configured to calculate the second voltage value of the voltage source from the low threshold voltage to the high threshold voltage according to the first calculation breakpoint and a second calculation breakpoint; and
a fourth calculation submodule 3033, configured to calculate the third voltage value of the voltage source from the high threshold voltage to a maximum value according to the second calculation breakpoint.

As described above, according to the voltage conversion apparatus in the simulation circuit provided by the present application, during simulation of the mixed-signal circuit, the first time point at which the voltage source reaches the low threshold voltage and the second time point at which the voltage source reaches the high threshold voltage can be obtained; the calculation breakpoints are inserted at the first time point and the second time point, respectively; and during simulation of the voltage source, the first voltage value, the second voltage value and the third voltage value are calculated according to the calculation breakpoints, and the first voltage value, the second voltage value and the third voltage value are converted into the digital signals, respectively. According to the present application, the calculation breakpoints are respectively inserted when the voltage source reaches the low threshold voltage and the high threshold voltage, so that variations of the voltage source are solved based on the calculation breakpoints, and invalid calculations are avoided, thereby improving the overall simulation speed and efficiency.

All the above technical solutions may be combined in any manner to form alternative embodiments of the present application, which will not be described in further detail herein.

Those skilled in the art may understand that all or some steps in the various methods of the above embodiments may be implemented by instructions, or implemented through the instruction controlling relevant hardware, and the instructions may be stored in a non-transitory computer-readable storage medium and loaded and executed by a processor.

Accordingly, an embodiment of the present application provides a non-transitory computer-readable storage medium storing a plurality of computer programs. The computer programs can be loaded by a processor to perform the steps of any of the voltage conversion methods in the simulation circuit according to the embodiments of the present application. For example, the computer programs may perform the following steps:
in the simulation of a mixed-signal circuit, a first time point at which a voltage source reaches a low threshold voltage and a second time point at which the voltage source reaches a high threshold voltage are obtained;
calculation breakpoints are inserted at the first time point and the second time point, respectively;
when the voltage source is simulated, a first voltage value, a second voltage value and a third voltage value are calculated according to the calculation breakpoints; and
the first voltage value, the second voltage value and the third voltage value are converted into digital signals, respectively.

The specific implementation of the above operations may be referenced to the preceding embodiments and will not be repeated here.

The non-transitory computer-readable storage medium may include: a read-only memory (ROM), a random access memory (RAM), a disk, an optical disc or the like.

Since the computer programs stored in the non-transitory computer-readable storage medium can execute the steps of any voltage conversion methods in the simulation circuit provided by the embodiments of the present application, the beneficial effects achievable by any voltage conversion method in the simulation circuit provided by the embodiments of the present application can be achieved. Details may be referenced to the preceding embodiments and will not be repeated here.

An embodiment of the present application further provides an electronic device, including a memory and a processor, where the memory is configured to store a computer program, and the processor is configured to invoke and execute the computer program from the memory, thereby causing the electronic device equipped with a chip to perform the methods described in the various possible embodiments above.

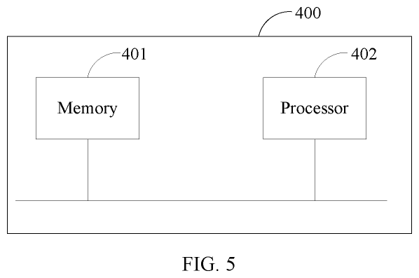

For example, the electronic device may be a terminal device with corresponding functions, such as a mobile phone, a tablet computer, a personal computer and a cloud computer. Referring to FIG. 5, FIG. 5 is a schematic structural diagram of an electronic device according to an embodiment of the present application.

The electronic device 400 may include components such as a memory 401 and a processor 402. Those skilled in the art may understand that a structure of the electronic device shown in FIG. 5 constitutes no limitation on the electronic device, and may include more or fewer components than those illustrated, or have a combination of some components, or have a different arrangement of components.

The memory 401 may be configured to store application programs and data. The application programs stored in the memory 401 contain executable code. The application programs may constitute various functional modules. The processor 402 executes various functional applications and data processing by running the application programs stored in the memory 401.

The processor 402 is a control center of the electronic device, and connects various parts of the electronic device using various interfaces and circuits, and performs various functions of the electronic device and processes data by running or executing the application programs stored in the memory 401 and by calling the data stored in the memory 401, thereby performing overall monitoring on the electronic device.

In this embodiment, the processor 402 in the electronic device may load an executable code corresponding to processes of one or more application programs into the memory 401 according to the following instructions, and run the application programs stored in the memory 401 to perform the following operations: in the simulation of a mixed-signal circuit, a first time point at which a voltage source reaches a low threshold voltage and a second time point at which the voltage source reaches a high threshold voltage are obtained;
calculation breakpoints are inserted at the first time point and the second time point, respectively;
when the voltage source is simulated, a first voltage value, a second voltage value and a third voltage value are calculated according to the calculation breakpoints; and
the first voltage value, the second voltage value and the third voltage value are converted into digital signals, respectively.

It should be understood that the above scenarios merely serve as examples and do not limit the application scenarios of the technical solution provided by the embodiments of the present application, and the technical solution of the present application may also be applied to other scenarios. For example, those skilled in the art can know that, with the evolution of system architecture and the emergence of new service scenarios, the technical solutions provided in the embodiments of the present application are also applicable to similar technical problems.

The steps of the methods in the embodiments of the present application may be re-ordered, combined, or omitted according to actual requirements. The modules in the electronic device of the embodiments of the present application may be combined, divided, or omitted according to actual requirements.

In the present application, for identical or similar terminological concepts, technical solutions and/or application scenarios, detailed descriptions are generally provided only upon their first occurrence. For subsequent repeated appearances, relevant descriptions are usually omitted for conciseness. In understanding the technical solutions and related content of the present application, any subsequently mentioned identical or similar terminological concepts, technical solutions and/or application scenario descriptions without detailed elaboration may be construed with reference to their prior detailed descriptions.

In the present application, the descriptions of each embodiment have respective focuses. For parts that are not described or recorded in an embodiment, refer to related descriptions in other embodiments.

Technical features of the technical solutions of the present application may be randomly combined. To make the description concise, not all possible combinations of the technical features in the foregoing embodiments have been described. However, the combinations of these technical features shall be considered as falling within the scope of the present application as long as no conflict exists.

The above embodiments may be implemented in whole or in part by software, hardware, firmware, or any combination thereof. When implemented by the software, they may be implemented in or in part in a form of a computer program product. The computer program product includes one or more computer instructions. When the computer instructions are loaded and executed on a computer, the processes or functions according to the embodiments of the present application are implemented in whole or in part. The computer may be a general-purpose computer, a special-purpose computer, a computer network, or other programmable apparatuses. The computer instructions may be stored in a computer-readable storage medium or transmitted from one computer-readable storage medium to another computer-readable storage medium. For example, the computer instructions may be transmitted from a website, computer, server, or data center to another website, computer, server or data center by wired (e.g., a coaxial cable, an optical fiber or a digital subscriber line) or wireless (e.g., infrared, radio and microwave, etc.) means. The computer-readable storage medium may be any available medium accessible by a computer, or a data storage device such as a server or a data center that incorporates one or more available media. The available medium may be a magnetic medium (e.g., a floppy disk, a hard disk or a magnetic tape), an optical medium (e.g., a DVD), a semiconductor medium (e.g., a solid state disk), or the like.

The voltage conversion method and apparatus in the simulation circuit, the electronic device and the non-transitory computer-readable storage medium provided in the embodiments of the present application are described above in detail. The principles and implementations of the present application are illustrated by applying specific examples herein. The descriptions of the above embodiments are merely for facilitating understanding of the method and its core idea. Meanwhile, those skilled in the art may make modifications to the specific implementations and application scopes according to the ideas of the present application. In conclusion, the contents of the specification should not be construed as a limitation to the present application.

What is claimed is:

1. A voltage conversion method in a simulation circuit, comprising:
during simulation of a mixed-signal circuit, obtaining a first time point at which a voltage source reaches a low threshold voltage and a second time point at which the voltage source reaches a high threshold voltage;
inserting calculation breakpoints at the first time point and the second time point, respectively;
during simulation of the voltage source, calculating a first voltage value, a second voltage value and a third voltage value according to the calculation breakpoints; and
converting the first voltage value, the second voltage value and the third voltage value into digital signals, respectively.

2. The voltage conversion method in a simulation circuit according to claim 1, wherein the step of calculating the first voltage value, the second voltage value and the third voltage value according to the calculation breakpoints comprises:
calculating the first voltage value of the voltage source from 0 to the low threshold voltage according to a first calculation breakpoint;
calculating the second voltage value of the voltage source from the low threshold voltage to the high threshold voltage according to the first calculation breakpoint and a second calculation breakpoint; and
calculating the third voltage value of the voltage source from the high threshold voltage to a maximum value according to the second calculation breakpoint.

3. The voltage conversion method in a simulation circuit according to claim 1, wherein before the step of obtaining the first time point and the second time point, the method further comprises:
determining whether the voltage source is a high-frequency linear voltage source; and
if the voltage source is the high-frequency linear voltage source, proceeding to perform the step of obtaining the first time point and the second time point.

4. The voltage conversion method in a simulation circuit according to claim 3, wherein the step of obtaining the first time point at which the voltage source reaches the low threshold voltage and the second time point at which the voltage source reaches the high threshold voltage comprises:
obtaining a rate of change of the high-frequency linear voltage source; and
calculating the first time point according to the rate of change and the low threshold voltage, and calculating the second time point according to the rate of change and the high threshold voltage.

5. The voltage conversion method in a simulation circuit according to claim 1, wherein the step of converting the first voltage value, the second voltage value, and the third voltage value into the digital signals, respectively comprises:
when the first voltage value, the second voltage value or the third voltage value is less than or equal to the low threshold voltage, setting a digital signal value correspondingly connected to the voltage source to 0;
when the first voltage value, the second voltage value or the third voltage value is greater than or equal to the high threshold voltage, setting a digital signal value correspondingly connected to the voltage source to 1; and
when the first voltage value, the second voltage value or the third voltage value is greater than the low threshold voltage and less than the high threshold voltage, setting a digital signal value correspondingly connected to the voltage source to x, where x is a logic value of an intermediate state.

6. An electronic device, comprising:
a memory, storing instructions; and
one or more processors, coupled to the memory and configured to execute the instructions to cause the electronic device to perform the following operations:
during simulation of a mixed-signal circuit, obtaining a first time point at which a voltage source reaches a low threshold voltage and a second time point at which the voltage source reaches a high threshold voltage;
inserting calculation breakpoints at the first time point and the second time point, respectively;
during simulation of the voltage source, calculating a first voltage value, a second voltage value and a third voltage value according to the calculation breakpoints; and
converting the first voltage value, the second voltage value and the third voltage value into digital signals, respectively.

7. The electronic device according to claim 6, wherein the step of calculating the first voltage value, the second voltage value and the third voltage value according to the calculation breakpoints comprises:
calculating the first voltage value of the voltage source from 0 to the low threshold voltage according to a first calculation breakpoint;
calculating the second voltage value of the voltage source from the low threshold voltage to the high threshold voltage according to the first calculation breakpoint and a second calculation breakpoint; and
calculating the third voltage value of the voltage source from the high threshold voltage to a maximum value according to the second calculation breakpoint.

8. The electronic device according to claim 6, wherein before the step of obtaining the first time point and the second time point, the one or more processors are further configured to execute the instruction to cause the electronic device to perform the following operations:
determining whether the voltage source is a high-frequency linear voltage source; and
if the voltage source is the high-frequency linear voltage source, proceeding to perform the operation of obtaining the first time point and the second time point.

9. The electronic device according to claim 8, wherein the step of obtaining the first time point at which the voltage source reaches the low threshold voltage and the second time point at which the voltage source reaches the high threshold voltage comprises:
obtaining a rate of change of the high-frequency linear voltage source; and
calculating the first time point according to the rate of change and the low threshold voltage, and calculating the second time point according to the rate of change and the high threshold voltage.

10. The electronic device according to claim 6, wherein the step of converting the first voltage value, the second voltage value, and the third voltage value into the digital signals, respectively comprises:
when the first voltage value, the second voltage value or the third voltage value is less than or equal to the low threshold voltage, setting a digital signal value correspondingly connected to the voltage source to 0;
when the first voltage value, the second voltage value or the third voltage value is greater than or equal to the high threshold voltage, setting a digital signal value correspondingly connected to the voltage source to 1; and
when the first voltage value, the second voltage value or the third voltage value is greater than the low threshold voltage and less than the high threshold voltage, setting a digital signal value correspondingly connected to the voltage source to x, where x is a logic value of an intermediate state.

11. A non-transitory computer-readable storage medium, storing instructions, wherein when executed by one or more processors, the instructions cause the one or more processors to perform the following operations:
during simulation of a mixed-signal circuit, obtaining a first time point at which a voltage source reaches a low threshold voltage and a second time point at which the voltage source reaches a high threshold voltage;
inserting calculation breakpoints at the first time point and the second time point, respectively;
during simulation of the voltage source, calculating a first voltage value, a second voltage value and a third voltage value according to the calculation breakpoints; and
converting the first voltage value, the second voltage value and the third voltage value into digital signals, respectively.

12. The non-transitory computer-readable storage medium according to claim 11, wherein the step of calculating the first voltage value, the second voltage value and the third voltage value according to the calculation breakpoints comprises:
calculating the first voltage value of the voltage source from 0 to the low threshold voltage according to a first calculation breakpoint;
calculating the second voltage value of the voltage source from the low threshold voltage to the high threshold voltage according to the first calculation breakpoint and a second calculation breakpoint; and
calculating the third voltage value of the voltage source from the high threshold voltage to a maximum value according to the second calculation breakpoint.

13. The non-transitory computer-readable storage medium according to claim 11, wherein before the step of obtaining the first time point and the second time point, the instructions further cause the one or more processors to perform the following operations:
determining whether the voltage source is a high-frequency linear voltage source; and
if the voltage source is the high-frequency linear voltage source, proceeding to perform the operation of obtaining the first time point and the second time point.

14. The non-transitory computer-readable storage medium according to claim 13, wherein the step of obtaining the first time point at which the voltage source reaches the low threshold voltage and the second time point at which the voltage source reaches the high threshold voltage comprises:
obtaining a rate of change of the high-frequency linear voltage source; and
calculating the first time point according to the rate of change and the low threshold voltage, and calculating the second time point according to the rate of change and the high threshold voltage.

15. The non-transitory computer-readable storage medium according to claim 11, wherein the step of converting the first voltage value, the second voltage value and the third voltage value into the digital signals, respectively comprises:
when the first voltage value, the second voltage value or the third voltage value is less than or equal to the low threshold voltage, setting a digital signal value correspondingly connected to the voltage source to 0;
when the first voltage value, the second voltage value or the third voltage value is greater than or equal to the high threshold voltage, setting a digital signal value correspondingly connected to the voltage source to 1; and
when the first voltage value, the second voltage value or the third voltage value is greater than the low threshold voltage and less than the high threshold voltage, setting a digital signal value correspondingly connected to the voltage source to x, where x is a logic value of an intermediate state.
